(19) United States
(12) Patent Application Publication
(10) Pub. No.: US 2007/0177269 A1
(43) Pub. Date: Aug. 2, 2007

(54) Safety Light or Reflector for Front and Side Edge of Snow Plow

(76) Inventor: Gerald DePaoli, Pawling, NY (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/670,495

(22) Filed: Feb. 2, 2007

Related U.S. Application Data
(60) Provisional application No. 60/764,567, filed on Feb. 2, 2006.

(51) Int. Cl. G02B 5/124

(52) U.S. Cl. 359/533

(57) ABSTRACT

A snow plow light or reflector system comprising a molded U, L, Z, S or flat shaped light or reflector clip for attachment to the side edge of a snow plow, said clip having a plurality of active or inactive light reflectors attached or attached thereto and means for affixing the clip to the snow plow.

### CROSS REFERENCE TO RELATED APPLICATION

This application claims benefit to provisional application 60/764,567 filed on Feb. 2, 2006, entitled Safety Design Reflector on Edge of Plow, which is incorporated by referenced herein in its entirety.

### FIELD OF THE INVENTION

The present invention is directed to the field of safety reflectors. In particular, the present invention is directed to the use of safety reflectors for snowplows to increase safety and avoid traffic accidents.

### BACKGROUND OF THE INVENTION

Each year there are tens of thousands of road accidents involving vehicles with snow plows. By definition, snow plows are used in inclement weather conditions, which often makes them difficult to see. Snow plows present particular safety issues because the plows frequently extend beyond the sides of the truck or vehicle with which they connect and they often block the visibility of head and fog lights.

There have been a number of U.S. Patents which relate to various aspects of reflector technologies, some of which are related to snow plows. U.S. Patent Application No. 20010028824 discloses a snowplowable pavement marker includes a frame member having primary spaced keel members with ramp surfaces which have upwardly inclined contours beginning at a forward end portion of each keel member and extending at a first acute angle, then transitions to a second portion having a second acute angle which is greater than the first angle. Further, the frame member includes an auxiliary keel member having ramp surfaces disposed between the primary keel members and having the same contour as the primary ramp surfaces. The auxiliary keel member ramp surfaces extend inwardly of the frame member to a point proximate the marker's reflector and serve to prevent damage by a snowplow blade set at a wide angle to the direction of blade travel. Advantageously, the contour of ramp surfaces permits a higher frame member installation above the pavement and allows for greater exposure of the reflector.

U.S. Patent Application 20020047532 discloses a one-piece headlight adapter, and a two-piece headlight adapter system, is used to connect the existing vehicle headlight controls and power supply with a snowplow wiring harness. An adapter only connects the controls and power supply for one headlight to the wiring harness. Two adapters, one for each headlight, create an adapter system. The adapter system allows the vehicle operator to control the snowplow headlights from the inside of the vehicle. One version of an adapter is a three-component adapter that includes one connection to the vehicle headlight, one connection to the headlight controls, and one connection to the wiring harness. Another version of the adapter is a five-component adapter that includes high and low beam connections to the vehicle headlight, high and low beam connections to the headlight controls, and one connection to the wiring harness. In each version, the connections of the adapter include a connection to the common ground which ensures a fixed potential on which the snowplow headlights operate.

U.S. Pat. No. 5,257,875 discloses a one-way snowplowable pavement marker having an auxiliary ramp at the front of a body portion connecting the spaced first and second primary ramps for supporting a snowplow blade tip when the tip is at angle up to 60.degree. from a line perpendicular to the direction of travel to protect a reflector in the marker. A cast-in-place shelf is formed behind the reflector for supporting the blade tip before and after it leaves the auxiliary ramp to prevent the reflector from being contacted by the snowplow blade.

U.S. Pat. No. 6,461,077 discloses a road marker base having locators or protrusions which are frangibly connected to the base. The pair of protrusions extend horizontally from the base in opposite directions and transverse to the direction of travel and include a bottom surface for engaging the top surface of the roadway adjacent the recess. The bottom surface defines the height of the reflector support surface relative to the road's top surface. A unidirectional base includes a reflector support surface adjacent one end of the base in the direction of travel capable of receiving and providing visibility of both faces of a standard bidirectional reflector.

U.S. Pat. No. 3,980,410 discloses a pavement marker having relatively fragile pavement marker housing and a snow plow frame for guiding snow plows and similar implements over the pavement marker housing. Retrodirective reflector elements may be included in the pavement marker housing. The snow plow frame includes a unitary sheet metal body adapted to be secured to the roadway surface and having a base member with a fore and aft axis that extends parallel to the direction of travel when the body is secured to the roadway, and a transverse axis perpendicular to the fore and aft axis. A pair of snow plow ramp sections are formed on the body on opposite sides of the fore and aft axis, each of the ramp sections including a pair of snow plow ramps extending in opposite directions from the transverse axis. Each of the snow plow ramps has an enlarged end adjacent the transverse axis and decreases in cross-section to a tip portion at the distal end thereof spaced from the transverse axis. An opening is formed in the base member for receiving and positioning the pavement marker housing relative to the frame, and a strap member extends from one ramp section to the other along the transverse axis to overlie the pavement marker housing.

U.S. Pat. No. 6,461,077 discloses a road marker base having locators or protrusions which are frangibly connected to the base. The pair of protrusions extend horizontally from the base in opposite directions and transverse to the direction of travel and include a bottom surface for engaging the top surface of the roadway adjacent the recess. The bottom surface defines the height of the reflector support surface relative to the road's top surface. A unidirectional base includes a reflector support surface adjacent one end of the base in the direction of travel capable of receiving and providing visibility of both faces of a standard bidirectional reflector.

U.S. Pat. No. 5,660,768 discloses a retroreflective structure which has a window side and a facet side. The facet side has a plurality of steps with treads and risers intersecting at an angle. The risers include an array of retroreflective elements. Preferably, the elements are cube-corner prisms. The method includes forming the structure by polymerizing a polymerizable material in a mold having a facet side including a tiered structure having a plurality of steps with treads and risers intersecting at an angle and wherein the risers include an array of retroreflective elements.

U.S. Pat. No. 6,861,134 discloses a retroreflective article which comprises a) a microporous substrate containing a plurality of pores which are less than 0.5.mu.m in diameter; and b) a layer of reflective material located on the surface of the substrate such that the reflective material layer at least partially obscures a plurality of the pores of the substrate. A method for the production of a reflective article comprises the steps of a) providing a substrate which contains pores which have a diameter of less than 0.5.mu.m; and b) applying a layer of reflective material to the substrate in such a way that the reflective material layer at least partially obscures a plurality of the pores of the substrate.

U.S. Pat. No. 6,451,408 discloses a retroreflective article that exhibits suitable retroreflective luminance under dry and dynamic wet conditions. The article includes an enclosed-lens retroreflective sheeting that, under dry conditions, exhibits a coefficient of retroreflective luminance of about 40 (millicandela/m.sup.2)/lux as measured by ASTM D 4061-94 and, under dynamic wet conditions the sheeting increases in coefficient of retroreflective luminance. The article further includes a plurality of retroreflective elements partially embedded in a light transmissible bonding layer on the front, reflective surface of the retroreflective sheeting.

U.S. Pat. No. 6,703,108 discloses a retroreflective pavement marking material comprising on the top surface thereof an enclosed-lens retroreflective sheet that comprises a monolayer of retroreflective elements wherein first portions of the monolayer are arranged in an upwardly contoured profile and second portions of the monolayer are arranged a lower, substantially planar position.

U.S. Pat. No. 4,747,981 discloses a method for molding a reflector of light-transmissive urethane, with a retroreflective pattern of a multiplicity of angled facets at the back surface of the reflector. In a mold cavity for the reflector there is provided a mold portion shaped to form the multiplicity of angled facets. Prior to filling of the mold, there is applied to the mold portion temporarily a transfer coating of a material which will maintain the angled facets reflective in a urethane reflector. A releasing agent is applied to the remainder of the mold other than the subject mold portion, then the mold is filled with urethane material. Once the urethane material has set, the mold is opened and the molded urethane is stripped off the special mold portion, leaving the transfer coating, which acts as a release coating, adhered to the angled facets.

As can be seen, the vast majority of technologies have related to road reflectors or to the reflector construction itself. Heretofore, there has been no adequate system for providing warning reflectors on snow or other types of vehicle driven plows or shovels.

It is an object of the present invention to provide a light or reflector system which can attach to a snow plow to enable the snow plow to be easily seen.

It is a further object of the present invention to provide a system whereby a snow plow can be easily marked with lights or reflectors.

It is a further object of the present invention to provide a snow plow light or reflector which can be reflective in multiple directions.

It is still a further object of the present invention to provide a system in which a snow plow can be easily seen from all sides.

These and other objects of the present invention will become apparent from the detailed description.

### SUMMARY OF THE INVENTION

In accordance, the invention is a snow plow light or reflector system comprising a molded U, L, Z, S or flat shaped light or reflector clip for attachment to the side edge of a snow plow, said clip having a plurality of active or inactive light reflectors attached or attached thereto and a means for affixing the clip to the snow plow.

In a further embodiment, the present invention is a snow plow light or reflector system comprising of at least one molded U, L, Z, S or flat shaped light or reflector clip comprising first and second major walls and a minor inner wall, said clip being configured to attach to the side edge of a snow plow, one major wall of the clip being beveled to lie flush against the plow surface, at least one light or reflector attached to the first major wall of the clip and means for affixing the clip to the snow plow.

In yet a further embodiment, the present invention is a snow plow light or reflector system comprising a light or reflector clip which is molded into a U, L, Z, S or flat shape with two major side walls and a minor inner wall, said clip configured to attach to the side of a snow plow with one major side of the clip being beveled to lie flush against the working surface of the snow plow, a plurality of lights or reflectors attached to the major and minor walls and means for affixing the clip to the snow plow.

In yet a further embodiment, the present invention is a snow plow light or reflector clip comprising of a material makeup of urethane, metals and polymer, two major walls and a minor inner wall, said walls being configured to attach to the side edge of a snow plow with at least one major wall of the clip being beveled to lie flush against the snow plow surface, a plurality of lights or reflectors attached to the major and minor walls of the clip and means for affixing the clip to the snow plow.

### BRIEF DESCRIPTION OF THE FIGURES

FIG. 1 is an isolated view of the present invention.

FIG. 2 is a front perspective view of the present invention in which the molded U and L shaped clips are shown in proximity to their location on a snow plow.

FIG. 3 is a front perspective view of the present invention attached to a snow plow.

FIGS. 4 and 5 are isolated views of the present invention in various molded shapes.

### DETAILED DESCRIPTION OF THE INVENTION

The present invention is described with reference to the enclosed Figures, wherein the same numbers are used where applicable. In particular, the present invention is broadly identified as a reflector system with an active or inactive light source that is mounted on the edge of a snow plow to reflect the front, back and side of the snow plow to oncoming traffic. The system is designed to be affixed to both of the side and front edges of the plow. Specifically, the invention provides a safety feature that allows drivers and oncoming traffic to see the edge of the snow plow.

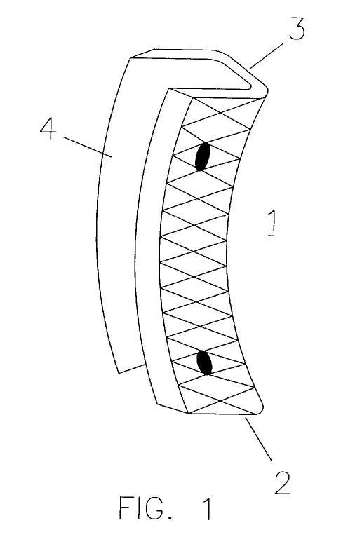

The invention is designed to be used when a snow plow is in either the elevated or in the downward position. Referring to FIG. 1, a preferred embodiment of the invention comprises a molded light or reflector clip 1. The clip 1 has two major surfaces or walls 2,3 and a minor inner surface 4.

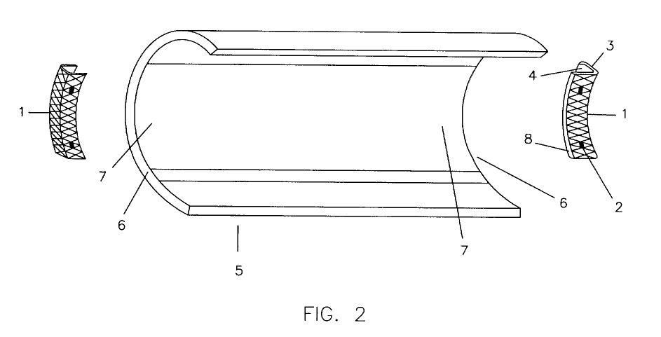

As FIG. 2 shows, the minor inner surface 4 of the clip 1 mates with the respective edges 6 of a snow plow 5. The major walls 2,3 of the clip 1 extend along the side edge 7 of the snow plow and have a tapered or beveled edge 8 on the major front surface 2. This allows snow to easily roll off the contact of the snow plow face.

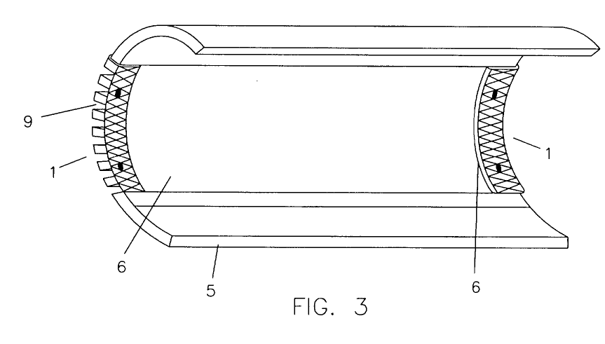

In FIG. 3, the clips 1 are shown attached to the respective edges 6 of a snow plow. In one embodiment, the clip 1 may have cuts 9 to allow for it to bend and fit the curve of the snow plow 5. In a most preferred embodiment, the clip 1 will be molded so as to be longitudinally curved and conform to the curvature of the snow plow 5. The light or reflector clip 1 can comprise a plurality of known reflector materials that provide suitable reflective properties. U.S. Pat. Nos. 6,451,408, 6,861,134 and 4,747,981 disclose potential reflective materials and are incorporated by reference.

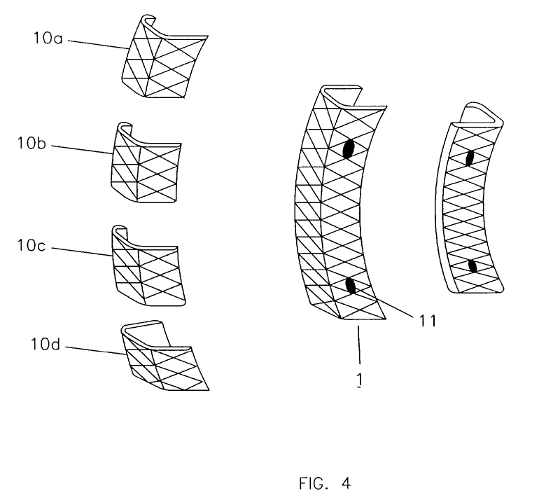

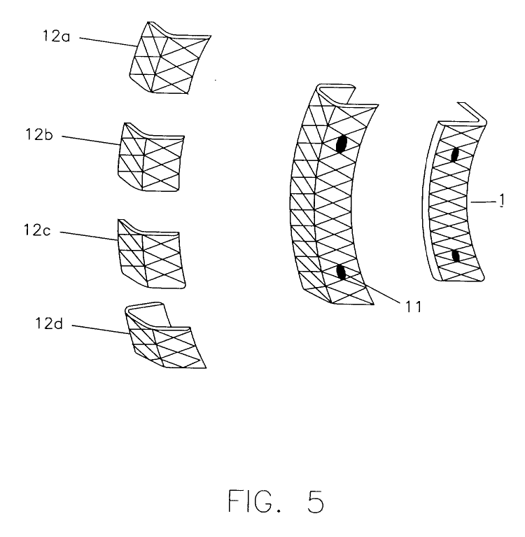

Referring to FIGS. 4 and 5, the clip 1 can be can be mounted by the use of epoxy, rivets or bolts 11 depending on the size of the snow plow and the intended application. The width of the light or reflector will be scaled to the snow plow size and application. The lights or reflectors can also be designed in 2-4 curved separate pieces (10a-10d; 12a-12d) for each side of the snow plow. These serve to alarm oncoming traffic as to where the end of the plow is.

The present invention has been described with reference to the enclosed Figures. The true nature and scope of the invention is determined with reference to the claims appended hereto. Specifically, while the present invention is developed in the context of a snow plow system, it is to be appreciated that the teachings of the present invention are applicable to a wide variety of vehicle driven plows and shovels.

I claim:

1. A snow plow light or reflector system comprising:
a molded U, L, Z, S or flat shaped light or reflector clip for attachment to the side edge of a snow plow,
said clip having a plurality of active or inactive light reflectors attached or attached thereto; and
means for attaching the clip to the snow plow.

2. A snow plow light or reflector system comprising:
at least one molded U, L, Z, S or flat shaped light or reflector clip comprising first and second major walls and a minor inner wall,
said clip being configured to attach to the side edge of a snow plow, one major wall of the clip being beveled to lie flush against the plow surface;
at least one light or reflector attached to the first major wall of the clip; and
means for affixing the clip to the snow plow.

3. A snow plow light or reflector system comprising:
a light or reflector clip which is molded into a U, L, Z, S or flat shape with two major side walls and a minor inner wall,
said clip configured to attach to the side of a snow plow with one major side of the clip being beveled to lie flush against the working surface of the snow plow;
a plurality of lights or reflectors attached to the major and minor walls; and
means for affixing the clip to the snow plow.

4. A snow plow light or reflector clip comprising:
a material makeup of urethane, metals and polymer;
two major walls and a minor inner wall,
said walls being configured to attach to the side edge of a snow plow with at least one major wall of the clip being beveled to lie flush against the snow plow surface;
a plurality of lights or reflectors attached to the major and minor walls of the clip; and
means for affixing the clip to the snow plow.
